(19) United States
(12) Patent Application Publication
(10) Pub. No.: US 2004/0153762 A1
(43) Pub. Date: Aug. 5, 2004

(54) Hardware driven state save/restore in a data processing system

(75) Inventors: David Walter Flynn, Cambridge (GB); Dominic Hugo Symes, Cherry Hinton (GB)

Correspondence Address: NIXON & VANDERHYE, PC, 1100 N GLEBE ROAD, 8TH FLOOR, ARLINGTON, VA, 22201-4714, US

(73) Assignee: ARM LIMITED, Cambridge (GB)

(21) Appl. No.: 10/691,501

(22) Filed: Oct. 24, 2003

(30) Foreign Application Priority Data
Nov. 13, 2002 (GB) 0226502.3

(51) Int. Cl. H04L 1/22

(52) U.S. Cl. 714/15

(57) ABSTRACT

State data from a circuit 2 is saved to a memory 14 via a system bus 4, 6, 8, 10 under control of a state saving controller 16. The state data may be captured within scan chains 12 provided for production test within the circuit with these scan chains supplying respective bits to the multi-bit state saving data words that are stored to the memory via the system bus.

### BACKGROUND OF THE INVENTION

1. Field of the Invention

This invention relates to the field of data processing systems. More particularly, this invention relates to data processing systems in which the system state is saved and restored under hardware control.

2. Description of the Prior Art

It is known to provide data processing systems in which the system state may be saved and restored. These mechanisms are particularly useful in circumstances such as power saving power down mode entry. In such circumstances it is determined, for example by detecting the system being at idle for a predetermined amount of time or the pressing of a power down key, that a switch to a power down mode is required. It is important that when this power down mode is exited, the system should return to its previous state unaltered such that processing operations can continue smoothly and efficiently. It would be highly disadvantageous if information/state was lost upon so as to require a full system reboot and initialisation upon restart.

In order to facilitate this type of power saving power down, it is known to provide power down software routines on data processing systems which are executed when entry to the power down mode is required and which serve to save to some non-volatile storage data capturing the state of the system such that a complementary piece of software can be run when the system resumes operation and this state information restored from the non-volatile storage such that processing can be recommenced at the same point and with the same system state. A significant disadvantage with this approach is that the software required to execute to save off the system state is relatively slow to execute, the same also being true with the software needed to restore the system state. Furthermore, there may be some system state information which is not accessible to the software responsible for saving the system state, such as for example cache memory contents, tightly coupled memory contents and other relatively low level hardware state information concerning the system. In such circumstances, when processing is resumed, it recommences in a way that only approximates the state of the system when power down occurred, such as for example there being a requirement to refill all of the cache memories which may be a relatively slow and power consuming operation. Furthermore on restarting the system some state, such as page table mappings, which is required for a simple restart is not available.

### SUMMARY OF THE INVENTION

Viewed from one aspect the present invention provides apparatus for processing data, said apparatus comprising:

a circuit used in processing data, said circuit having one or more nodes operable to store one or more data values that together define a state of said circuit;

a memory operable to store data;

a system bus coupled to said circuit and said memory and operable to transfer multi-bit data words between said circuit and said memory in response to memory transfer requests issued upon said system bus during normal processing operation of said circuit and said memory; and

a state saving controller coupled to said circuit and said system bus and operable in response to a state saving trigger to read said data values defining a state of said circuit from said one or more nodes and to generate a sequence of memory write requests on said system bus that write one or more state saving multi-bit data words representing said data values into said memory such that said state of said circuit is restorable using said one or more state saving multi-bit data words.

The invention utilises the existing system bus and memory within the data processing system to provide a way of saving off data values representing the system state under the control of special purpose state saving controller hardware. Surprisingly, by reusing the system bus and memory which are already provided, the state saving controller can be simple and yet achieve the strongly desirable function of rapidly and efficiently saving and later restoring the system state with an advantageous degree of completeness.

Whilst it will be appreciated that the circuit of which the state is being saved may take a wide variety of different forms, one particular situation in which the present technique is advantageous is when the circuit is a processor core. Processor cores typically store critical state information, such as register values, cache memory contents, processing status flags and the like which is relatively slow, difficult and inefficient to access under software control and yet should or must be saved if a proper save/restore capability is to be achieved.

Whilst it will be appreciated that the data values may be read from the circuit in a variety of different ways, preferred embodiments of the invention use scan chain cells to capture the data values representing the state of the circuit with these scan chain cells then being serially read under control of the state saving controller to generate the multi-bit state saving words which are stored off to memory.

It is particularly convenient to use an embodiment having multiple scan chain cells with each scan chain cell serving to supply a respective bit of the multi-bit state saving data word as the scan chains are serially clocked.

Another strongly advantageous feature associated with the use of scan chain cells for capturing the state data values is that such scan chain cells are typically already provided within many circuits for the function of circuit testing and yet once the circuit has been initially tested upon manufacture, these scan chain cells are not further used. The present technique reuses these same scan chain cells to provide a save/restore capability at very little additional overhead. Furthermore, since the test related use of the scan cells requires thorough coverage of the circuit state, it is generally the case that there is already provided a scan chain cell associated with each data value needed to properly and accurately save and restore the circuit state.

Another example of a circuit which may have its state saved for save/restore operations is a memory circuit. Such a memory may for example be a cache memory, a tightly coupled memory or another type of memory associated with a data processing system. The data held within these memories forms a part of the overall system state and is something which should be accurately saved and restored if possible.

In the context of saving and restoring data values held within a circuit which is a memory, preferred embodiments of the invention reuse the built-in self-test circuitry which is often associated with such memories to test them at the manufacture stage by generating a series of test patterns which are written to and read from the memories to also serve to read the data values from the memory as a sequence of multi-bit state saving data words which are to be saved off to a different memory via the system bus.

The speed with which the state data may be saved and restored is improved in embodiments in which burst mode memory transfers are used to store the data to the memory and to restore the data from the memory.

As will be appreciated, preferred embodiments of the invention may advantageously utilise the state saving controller to respond to a state restoring trigger to generate a sequence of memory read requests on the system bus that read the state data from the memory and write that state data to the nodes from which it was saved within the circuit.

In the context of such restore operations, the same mechanisms such as reuse of the test scan chains and the built-in self test controllers of memories may be advantageously adopted.

The flexibility of this save/restore technique is advantageously improved in preferred embodiments in which the multi-bit state saving data words are stored at memory addresses that are user specified, such as starting from a base address which is stored in a user accessible register etc.

The state saving trigger may take a wide variety of different forms. However, in preferred embodiments the state saving trigger includes the ability to initiate state saving in response to execution of a state saving program instruction. Alternative triggers may be detection of the pressing of a power down key, a reduction in battery reserves below a threshold value or the like.

One particularly preferred use of the present technique which demonstrates its applicability in other than power down situations is where the state saving trigger is initiation of a diagnostic test upon the circuit. In some safety critical real time processing environments it is a requirement that the circuits should self-test themselves at defined intervals. In this situation the present technique may be used to rapidly save the system state such that diagnostic tests may be freely performed and yet permit rapid restoration of that state such that normal processing can resume.

Viewed from another aspect the present invention provides a method of saving state within an apparatus for data processing having:

a circuit used in processing data, said circuit having one or more nodes operable to store one or more data values that together define a state of said circuit;

a memory operable to store data; and

a system bus coupled to said circuit and said memory and operable to transfer multi-bit data words between said circuit and said memory in response to memory transfer requests issued upon said system bus during normal processing operation of said circuit and said memory; said method comprising the steps of:

in response to a state saving trigger using a state saving controller coupled to said circuit and said system bus to read said data values defining a state of said circuit from said one or more nodes and to generate a sequence of memory write requests on said system bus that write one or more state saving multi-bit data words representing said data values into said memory such that said state of said circuit is restorable using said one or more state saving multi-bit data words.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates a processor core surrounded by a system bus interface;

FIG. 2 schematically illustrates the sub-system of FIG. 1 with the provision of level shifters in the system bus to enable power down insolation;

FIG. 3 schematically illustrates a processor core reusing scan chain cells under control of a state saving controller to store and restore system state;

FIG. 4 schematically illustrates a portion of a scan chain which enables data values at different nodes within a circuit to be captured and restored;

FIG. 5 schematically illustrates an alternative embodiment in which the circuit for which state is being saved is a memory;

FIG. 6 is a flow diagram schematically illustrating the saving of system state; and

FIG. 7 is a flow diagram schematically illustrating the restoring of system state.

### DESCRIPTION OF THE PREFERRED EMBODIMENTS

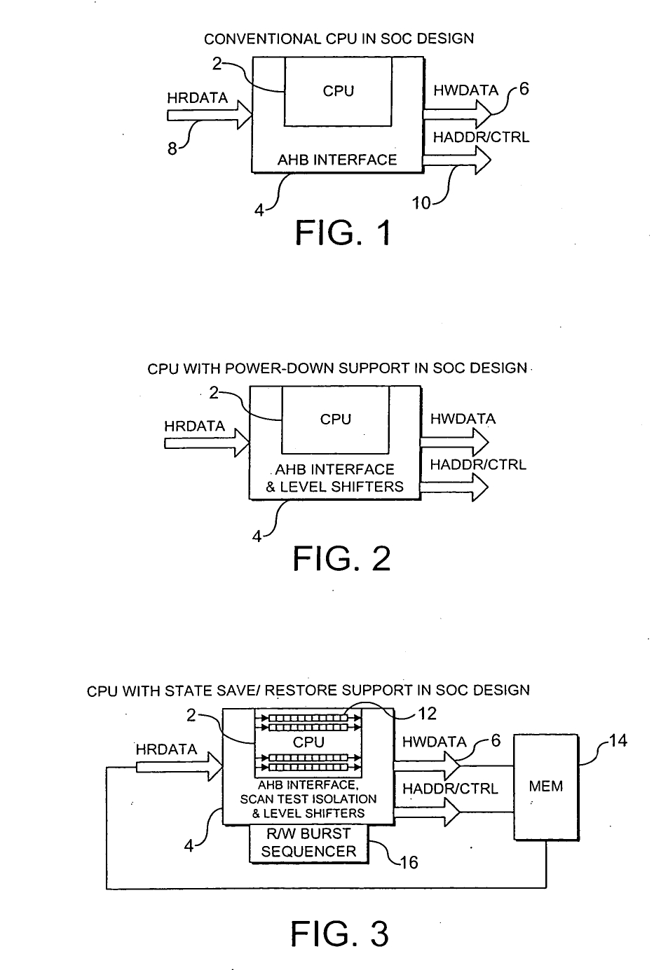

FIG. 1 schematically illustrates a processor core 2 surrounded by an AMBA High-performance Bus (AHB) interface 4 which interfaces to the system bus that includes write data lines 6, read data lines 8 and address/control data lines 10. The processor core 2 could be a variety of different types of processor core, such as those produced by ARM Limited of Cambridge, England. The system bus 6, 8, 10 contects the processor core 2 with various other circuit elements in the system including a memory (not illustrated) as well as other peripherals and possibly other processors.

FIG. 2 schematically illustrates the system of FIG. 1 modified to provide level shifters within the AHB interface 4. These level shifters operate during power up and power down situations to tie the signal levels on the system bus to well defined values rather than allowing these to float in a way which may result in disadvantageous excessive power consumption or faulty operation. In operation, the system of FIG. 2 would typically use a special purpose software routine to save off to memory in response to a sequence of store instructions as much state information from the processor core 2 as was possible and/or desirable, e.g. register contents, program status values, program counter values, configuration register values etc. Once the state data has been safely saved to memory, the system may be powered down with the level shifters in the AHB interface 4 serving to prevent the problems previously discussed.

FIG. 3 schematically illustrates a first example system in accordance with the present technique. In this embodiment the serial scan chains 12 which are provided within the processor core 2 for production test reasons are reused for save/restore operations. More particularly, 32 such scan chains 12 are provided with each serving to supply a respective bit within a 32-bit state saving data word which will be saved off to the memory 14. More particularly, one end of each of the scan chains 12 can be connected to a respective bit of the write data bus lines 6 to form the data word to be written to the memory 14 and then the scan chains 12 all serially clocked to advance the data values by one stage such that the next 32 data values can be stored out as the next state saving data word.

A state saving controller 16 is added to the AHB interface 4 and is responsive to a state saving trigger to cause the scan chains 12 to capture state representing data values from their associated nodes within the processor core 2. The state saving controller 16 then clocks the scan chains 12 to form the state saving data words and generates the appropriate address control signals on the system bus to cause a data transfer from the processor core 2 to the memory 14 to take place. The state saving controller 16 can utilise burst mode transfers in order to improve efficiency.

The state saving controller 16 may response to a state saving trigger in the form of a program instruction executed by the processor core 2, such as a store to a predetermined address dedicated to this function, or a coprocessor instruction for a coprocessor dedicated to this function, or the like. Alternatively, the state saving trigger could be the pressing of a power key, the falling of a battery level below a predetermined level or the like.

When a state restore operation is required, the state saving controller 16 responds to a state restoring trigger to cause a burst read of the stored state data words from the memory 14 back into the scan chains 12 which are serially clocked as each saved state data word arrives. Once all the state has been stored back into the scan chains 12 these are used to apply those data values to the corresponding nodes within the processor core 12 to restore its state and normal processing resumed.

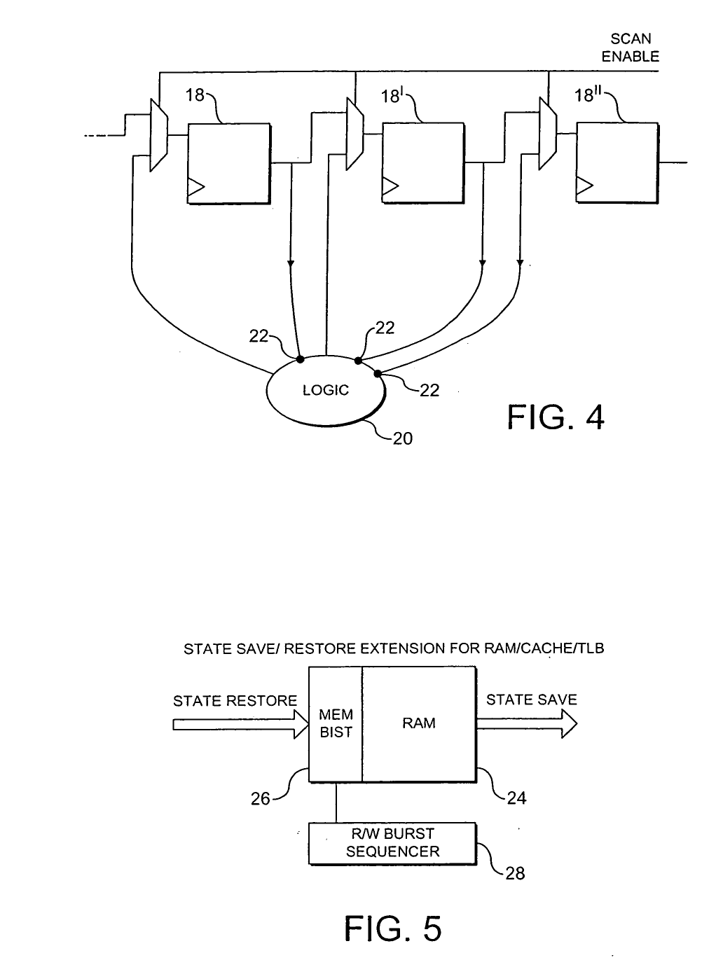

FIG. 4 schematically illustrates a portion of a scan chain comprising three registers 18 which may be either be serially connected to form a scan chain under control of a scan enable signal or alternatively provide a signal value store for the functional logic 20. In the example illustrated the two data values stored within the registers 18, 18′ to the left of the figure are inputs to the functional logic which cause a corresponding output to be generated and stored within the register 18″. The corresponding nodes 22 are shown within the functional circuitry 20.

FIG. 5 schematically illustrates a different embodiment in which the circuit for which state is being saved is a memory. In this context a random access memory 24 is provided with its own memory built-in self-test (BIST) controller 26 which for production test generates test patterns which are written to and read from the random access memory 24. In save/restore operation a state saving controller 28 reuses the address generating capabilities of the built-in self-test controller 26 to read a sequence of data words out of the random access memory 24 and drive these as a burst mode write onto the system bus where they can then be saved into the memory 14. When a restore occurs, the built-in self-test controller 26 can be reused to generate the addresses to which the saved state data words are written within the random access memory 24.

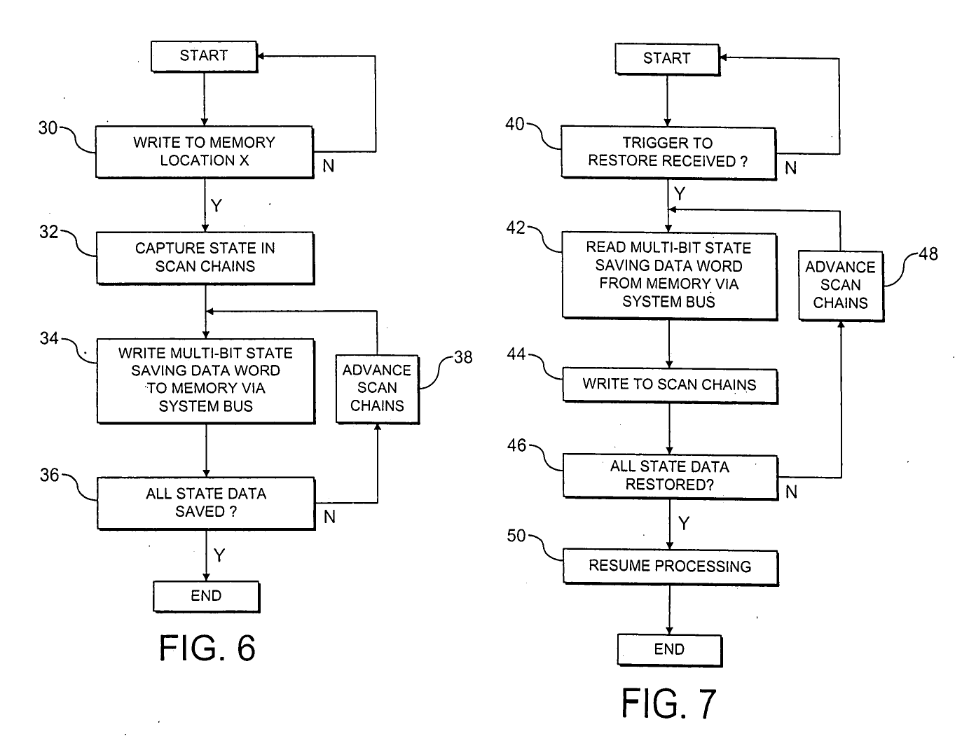

FIG. 6 is a flow diagram schematically illustrating the save operation within the embodiment of FIG. 3. At step 30, the state saving controller waits until a write to a predetermined memory location X is detected. This write is the state saving trigger. (Other triggers could be a coprocessor instruction or a main core processor instruction.) When this state saving trigger occurs, processing proceeds to step 32 at which the state saving controller sends appropriate signals to the 32 scan chains 12 to capture their associated data values representing the state of the processor core 2 into the corresponding scan chain cells.

At step 34, a multi-bit state saving data word is written out onto the system bus and saved into the memory. This can be part of a burst mode transfer. At step 36 it is determined whether all of the state data has yet been saved. If there is more state data to save, then processing proceeds to step 38 at which all of the scan chains are serially advanced one position such that the next multi-bit state saving data word will be present upon the write data lines from which it may be saved off to the memory. When all of the state data has been saved, then the state saving controller can initiate the power down of the processor core 2 with the required state defining data safely saved within the memory 14.

FIG. 7 schematically illustrates the restore operation following the save operation of FIG. 6. At step 40, the system waits for a trigger to restore the system state to be received. In practice this could be the receipt of an external interrupt signal, the pressing of a power key or the like. When such a trigger to restore has been received, processing proceeds to step 42 at which a multi-bit state saving data word is read from the memory via the system bus. This multi-bit state saving data word is then written into the scan chains 12 with one bit from the data word going into each of the 32 scan chains at step 44. Step 46 determines whether all of the state data has yet been restored and if the data has not yet all been received then processing proceeds to step 48. Step 48 advances the scan chains by serially clocking them one position and returns processing to step 42 where the next multi-bit state saving data word can be read from the memory 14. The operations illustrated in FIG. 7 are all controlled and driven by the state saving controller.

When step 46 determines that all the state data has been restored, then processing proceeds to step 50 at which the processor core is restarted and processing resumed starting from the same system stage at which the system save was made, e.g the instruction after the state saving trigger operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1 Apparatus for processing data, said apparatus comprising:
a circuit used in processing data, said circuit having one or more nodes operable to store one or more data values that together define a state of said circuit;
a memory operable to store data;
a system bus coupled to said circuit and said memory and operable to transfer multi-bit data words between said circuit and said memory in response to memory transfer requests issued upon said system bus during normal processing operation of said circuit and said memory; and
a state saving controller coupled to said circuit and said system bus and operable in response to a state saving trigger to read said data values defining a state of said circuit from said one or more nodes and to generate a sequence of memory write requests on said system bus that write one or more state saving multi-bit data words representing said data values into said memory such that said state of said circuit is restorable using said one or more state saving multi-bit data words.

2. Apparatus as claimed in claim 1, wherein said circuit is a processor core.

3. Apparatus as claimed in claim 1, wherein said one or more nodes are each coupled to a respective scan chain cell within said circuit, said state saving controller being operable in response to said state saving trigger to store said data values within respective scan chain cells and to serially read said data values from said scan chain cells to form said one or more state saving multi-bit data words.

4. Apparatus as claimed in claim 3, comprising a plurality of scan chains each containing a plurality of scan chain cells, said plurality of scan chains operating in parallel to provide respective bits that together form a state saving multi-bit data word as said plurality of scan chains of serially read.

5. Apparatus as claimed in claim 3, wherein said scan chain cells are also operable to perform test functions upon said circuit.

6. Apparatus as claimed in claim 1, wherein said circuit is a further memory and said data values are bits of data words stored in said further memory.

7. Apparatus as claimed in claim 6, wherein said further memory is coupled to a built-in self-test controller operable to perform self-test operations upon said further memory and said state saving controller uses said built-in self-test controller to read data values from said further memory to form said state saving multi-bit data words.

8. Apparatus as claimed in claim 1, wherein said memory transfers are burst mode memory transfers.

9. Apparatus as claimed in claim 1, wherein said state saving controller is operable in response to a state restoring trigger to generate a sequence of memory read requests on said system bus that read said one or more multi-bit state saving data words from said memory via said system bus and write said data values represented by said multi-bit state saving data words to said one or more nodes to thereby restore said state of said circuit.

10. Apparatus as claimed in claim 1, wherein said multi-bit state saving data words are stored in a user specified region of said memory.

11. Apparatus as claimed in claim 1, wherein said state saving trigger comprises execution of a state saving program instruction.

12. Apparatus as claimed in claim 1, wherein said state saving trigger comprises initiation of a diagnostic test upon said circuit.

13. A method of saving state within an apparatus for data processing having:
a circuit used in processing data, said circuit having one or more nodes operable to store one or more data values that together define a state of said circuit;
a memory operable to store data; and
a system bus coupled to said circuit and said memory and operable to transfer multi-bit data words between said circuit and said memory in response to memory transfer requests issued upon said system bus during normal processing operation of said circuit and said memory; said method comprising the steps of:
in response to a state saving trigger using a state saving controller coupled to said circuit and said system bus to read said data values defining a state of said circuit from said one or more nodes and to generate a sequence of memory write requests on said system bus that write one or more state saving multi-bit data words representing said data values into said memory such that said state of said circuit is restorable using said one or more state saving multi-bit data words.

14. A method as claimed in claim 13, wherein said circuit is a processor core.

15. A method as claimed in claim 13, wherein said one or more nodes are each coupled to a respective scan chain cell within said circuit, said state saving controller being operable in response to said state saving trigger to store said data values within respective scan chain cells and to serially read said data values from said scan chain cells to form said one or more state saving multi-bit data words.

16. A method as claimed in claim 15, comprising a plurality of scan chains each containing a plurality of scan chain cells, said plurality of scan chains operating in parallel to provide respective bits that together form a state saving multi-bit data word as said plurality of scan chains of serially read.

17. A method as claimed in claim 15, wherein said scan chain cells are also operable to perform test functions upon said circuit.

18. A method as claimed in claim 13, wherein said circuit is a further memory and said data values are bits of data words stored in said further memory.

19. A method as claimed in claim 18, wherein said further memory is coupled to a built-in self-test controller operable to perform self-test operations upon said further memory and said state saving controller uses said built-in self-test controller to read data values from said further memory to form said state saving multi-bit data words.

20. A method as claimed in claim 13, wherein said memory transfers are burst mode memory transfers.

21. A method as claimed in claim 13, wherein said state saving controller is operable in response to a state restoring trigger to generate a sequence of memory read requests on said system bus that read said one or more multi-bit state saving data words from said memory via said system bus and write said data values represented by said multi-bit state saving data words to said one or more nodes to thereby restore said state of said circuit.

22. A method as claimed in claim 13, wherein said multi-bit state saving data words are stored in a user specified region of said memory.

23. A method as claimed in claim 13, wherein said state saving trigger comprises execution of a state saving program instruction.

24. A method as claimed in claim 13, wherein said state saving trigger comprises initiation of a diagnostic test upon said circuit.
